(19) United States
(12) Patent Application Publication
(10) Pub. No.: US 2006/0125151 A1
(43) Pub. Date: Jun. 15, 2006

(54) Pressure and temperature guidance in an in-mold coating process

(75) Inventors: Douglas S. McBain, Wadsworth, OH (US); Elliott J. Straus, akron, OH (US); John A. Thompson, Wooster, OH (US)

Correspondence Address: Omnova Solutions Inc;Law Department, 175 Ghent Road, Fairlawn, OH, 44333-3300, US

(73) Assignee: OMNOVA Solutions, Inc.

(21) Appl. No.: 10/534,264

(22) PCT Filed: Nov. 6, 2003
(86) PCT No.: PCT/US03/35305

§ 371 Date: Nov. 14, 2005

(51) Int. Cl. B29C 45/00

(52) U.S. Cl. 264/328.8

(57) ABSTRACT

An in-mold coating method wherein the time at which a coating substrate is injected onto a surface of a molded substrate is determined by the internal mold temperature and/or pressure. By regulating the point at which the in-mold coating is injected based on the internal mold temperature and/or pressure, an operator can assure that the in-mold coating is injected when the surface of the molded substrate is in an ideal condition for in-mold coating adhesion.

### BACKGROUND OF THE INVENTION

The present invention relates to an in-mold coating method using in-mold temperature and/or pressure to regulate the injection time. More particularly, the present invention relates to an in-mold coating method wherein the time at which the coating substrate is injected is determined by the internal mold temperature and/or pressure. The present invention finds particular application in respect to the in-mold coating of thermoplastic parts. It is to be appreciated, however, that the invention may relate to other similar environments and applications.

Molded thermoplastic and thermoset articles, such as those made from polyolefins, polycarbonates, polyesters, polystyrenes and polyurethanes, are utilized in numerous applications including those for automotive, marine, recreation, construction, office products, and outdoor equipment industries. Often, application of a surface coating to a molded thermoplastic or thermoset article is desirable. For example, molded articles may be used as one part in multi-part assemblies; to match the finish of the other parts in such assemblies, the molded articles may require application of a surface coating that has the same finish properties as the other parts. Coatings may also be used to improve surface properties of the molded article such as uniformity of appearance, gloss, scratch resistance, chemical resistance, weatherability, and the like. Also, surface coatings may be used to facilitate adhesion between the molded article and a separate finish coat to be later applied thereto.

Numerous techniques to apply surface coatings to molded articles have been developed. Many of these involve applying a surface coating to molded articles after they are removed from their molds. These techniques are often multi-step processes involving surface preparation followed by spray-coating the prepared surface with paint or other finishes. In contrast, IMC provides a means of applying a surface coating to a molded article prior to its ejection from the mold.

Historically, much work with IMCs has been done on molded articles made from thermosets. Thermosets such as, e.g., phenolics, epoxies, cross-linked polyesters, and the like, are a class of plastic composite materials that are chemically reactive in their fluid state and are set or cured by a reaction that causes cross-linking of the polymer chains. Once cured, subsequent heating may soften a thermoset but will not restore it to a fluid state.

More recently, there has been an interest in IMC articles made from thermoplastics. Thermoplastics are a class of plastic materials that can be melted, cooled to a solid form, and repeatedly re-melted and solidified. The physical and chemical properties of many thermoplastic materials, together with their ease of moldability, make them materials of choice in numerous applications in the automotive, marine, recreation, construction, office products, outdoor equipment and other fields.

Various methods have been used to apply coating to molded thermoset and thermoplastic articles. For example, the coatings can be sprayed onto the surface of an open mold prior to closing. However, spray coating can be time-consuming and, when the coating is applied using a volatile organic carrier, may require the use of containment systems. Other coating processes involve lining the mold with a preformed film of coating prior to molding. The drawback of this process is that, on a commercial scale, it can be cumbersome and costly.

Processes have also been developed wherein a fluid coating is injected onto and dispersed over the surface of a molded part and cured. A common method of injecting a fluid IMC onto the surface of a molded article involves curing (if a thermoset material) and cooling an article in the mold to the point that it has hardened sufficiently to accept the coating, reducing the pressure against the telescoping mold half to crack open or part the mold, injecting the fluid coating, and re-pressurizing the mold to distribute the coating over the surface of the molded article. The cracking or parting of the mold involves releasing the pressure exerted on the telescoping mold half to sufficiently move it away from the molded article, thereby creating a gap between the surface of the part and the telescoping mold half. The gap allows coating to be injected onto the surface of the part without needing to remove the part from the mold.

Other process, such as injection molding, requires that pressure on the movable mold half be maintained so as to keep the cavity closed and to prevent resin from escaping along the parting line. Further, maintaining pressure on the resin material during molding, which also requires keeping the cavity closed, often is necessary to assist in providing a more uniform crystalline or molecular structure in the molded article. Without such packing, physical properties of the molded article tend to be impaired.

In addition to the problem of resin escaping along the parting line, packing constraints can sometimes create other problems when an IMC composition is to be injected into a mold containing a molded article. Specifically, some commercially available IMCs are generally thermoset materials that cure by the application of heat. Curing of these compositions is often achieved through transfer of residual heat from the molded article. Were the coating composition to be injected after a molded article has been sufficiently packed to allow the mold to be depressurized and parted or cracked, the molded article may lack sufficient residual heat to cure the coating. Thus, for coating compositions designed to cure on an article, it is desirably injected prior to depressurizing the mold.

Because injection molding does not permit the mold to be parted or cracked prior to injection of the IMC composition into the mold cavity, the IMC composition must be injected under sufficient pressure to compress the article in all areas to be coated. The compressibility of the molded article dictates how and where the IMC composition covers it. The process of coating an injection molded article with a liquid IMC composition is described in, for example, U.S. Pat. No. 6,617,033 and U.S. Patent Publication Nos. 2002/0039565 A1 and 2003/00823244 A1.

One important parameter that must be monitored and controlled to ensure acceptable part performance and appearance when using a liquid in-mold coating to coat an injection molded thermoplastic article is the precise timing of when to inject the in-mold coating into the cavity in relation to the molding process. As will be discussed in more detail below, the in-mold coating is preferably injected into the mold at the point when the surface of the thermoplastic substrate resin adjacent the mold wall has cooled to just below its melting temperature. At this point the thermoplastic is stiff enough to accommodate the IMC while still retaining enough compressability for the IMC to completely coat the thermoplastic substrate.

A need therefore exists for a method for controlling the precise stage of the molding process at which the IMC is injected into the mold to ensure that the IMC is injected at the point when the thermoplastic has cooled to a temperature just below its melting temperature. This is accomplished in the present invention by monitoring the pressure and/or temperature inside the mold and injecting the IMC at a point when the pressure and/or temperature reach optimum values, indicating sufficient cooling of the thermoplastic.

### BRIEF DESCRIPTION OF THE INVENTION

In a first embodiment, the invention provides a method for determining when to inject a coating for contacting a surface of a molded article in a mold in an in-mold coating process, the method including the steps of determining an internal mold pressure after a mold has been filled with a predetermined amount of a thermoplastic; monitoring over time the internal mold pressure as the thermoplastic cools in the mold; and determining from a change in the internal pressure that a surface of the thermoplastic has cooled to below its melt temperature.

In a second embodiment, the invention provides a method for in-mold coating a thermoplastic substrate, the method including the steps of injecting a thermoplastic substrate into a closed mold, wherein at least one of an internal mold temperature and an internal mold pressure is monitored; allowing a surface of the thermoplastic to cool to a point below its melting temperature to form a molded article; injecting a coating into the closed mold such that the coating contacts at least a part of the surface of the thermoplastic, wherein the coating is injected at a point wherein at least one of the internal mold temperature and internal mold pressure is indicative of the point when the thermoplastic has cooled to below its melting temperature

### BRIEF DESCRIPTION OF THE DRAWINGS

The invention may take physical form in various components and arrangements of components, and in various steps and arrangements of steps. The drawings are only for purposes of illustrating preferred embodiments and are not to be construed as limiting the invention.

FIG. 1 is a side view of a molding apparatus having a movable mold half and a stationary mold half suitable for use in one embodiment of the present invention.

FIG. 2 is a partial cross-sectional view of the molding apparatus of FIG. 1 showing the movable mold half and the stationary mold half wherein the movable mold half is in a closed position to form a mold cavity, the mold cavity includes orifices for receiving first and second composition injectors.

FIG. 3 is a perspective view of an in-mold coating dispense and control apparatus adapted to be connected to the molding apparatus of FIG. 1 suitable for use in practicing one embodiment of the present invention.

FIG. 4 is a graph showing the Pressure-Specific Volume-Temperature (PVT) relationship of a typical thermoplastic substrate.

### DETAILED DESCRIPTION OF THE INVENTION

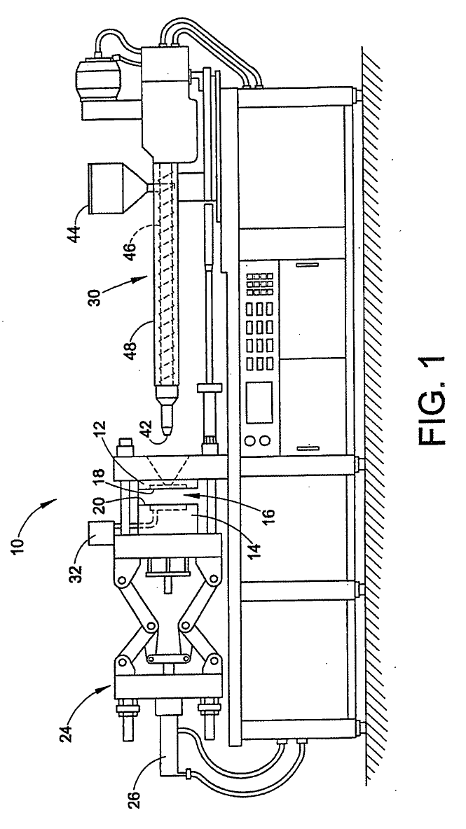

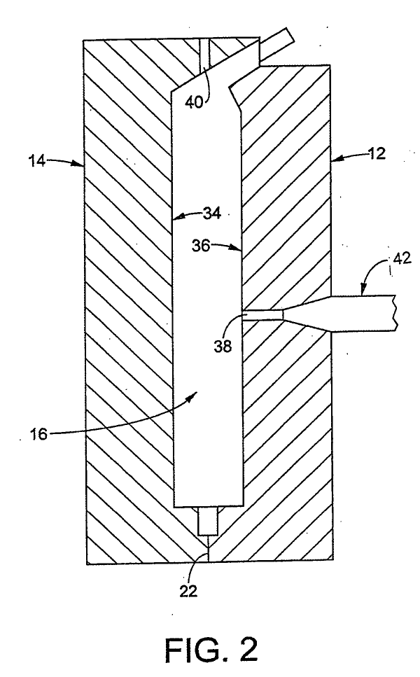

Referring now to the drawings wherein the showings are for purposes of illustrating a preferred embodiment of the invention only and not for purposes of limiting the same, FIG. 1 shows a molding apparatus or injection molding machine 10, in who's operation the present invention finds particular utility. The molding apparatus 10 includes a first mold half 12 which preferably remains in a stationary or fixed position relative to a second moveable mold half 14. FIG. 1 shows the movable mold half 14 in an open position. The first mold half 12 and second mold half 14 are adapted to mate with one another to form a contained mold cavity 16 therebetween (See FIG. 2). The mold halves 12,14 mate along surfaces 18 and 20 (FIG. 1) when the molding apparatus is in the closed position, forming a parting line 22 (FIG. 2) therebetween and around the cavity 16.

The moveable mold half 14 reciprocates generally along a horizontal axis relative to the first or fixed mold half 12 by action of a clamping mechanism 24 with a clamp actuator 26 such as through a hydraulic or pneumatic actuator as known in the art. The clamping pressure exerted by the clamping mechanism 24 should have a clamping pressure in excess of the pressures generated or exerted by either of a pair of composition injectors 30,32. In the preferred embodiment, the pressure exerted by the clamping mechanism 24 ranges generally from about 2,000 pounds per square inch (psi) or 13.8 MPa to about 15,000 psi or 103.3 MPa, preferably from about 4,000 psi or 27.6 MPa to about 12,000 psi or 82.7 MPa, and more preferably from about 6,000 psi or 41.3 MPa to about 10,000 psi or 68.9 MPa of the mold surface.

With reference to FIG. 2, the mold halves 12,14 are shown in a closed position abutting or mating with one another along the parting line 22 to form the mold cavity 16. It should be readily understood by those skilled in the art that the design of the cavity can vary greatly in size and shape according to the desired end product or article to be molded. The mold cavity 16 generally has a first surface 34 on the second mold half 14 and a corresponding or opposite second surface 36 on the first mold half 12. The mold cavity also contains separate orifices 38,40 to allow the composition injectors 30,32 to inject their respective compositions thereinto.

With reference back to FIG. 1, the first composition injector 30 is that of a typical injection molding apparatus which is well known to those of ordinary skill in the art. The first composition injector 30 is generally capable of injecting a thermoplastic composition, generally a resin or polymer, into the mold cavity 16. Owing to space constraints, the first injector 30 used to inject the thermoplastic composition may positioned to inject material from the fixed half 12 of the mold. It is to be understood that the first composition injector 30 could be reversed and placed in the movable mold half. Likewise, it is to be understood that the second injector 32, which is shown positioned in the movable mold half 14, could be alternatively positioned in the stationary mold half 12.

The first composition injector 30 is shown in a “backed off” position, but it is readily understood that the same can be moved in a horizontal direction so that a nozzle or resin outlet 42 of the first injector mates with the mold half 12. In the mated position, the injector 30 is capable of injecting its contents into the mold cavity 16. For purposes of illustration only, the first composition injector 30 is shown as a reciprocating-screw machine wherein a first composition can be placed in a hopper 44 and a rotating screw 46 can then move the composition through a heated extruder barrel 48, where the first composition or material is heated above its melting point. As the heated material collects near the end of the barrel, the screw 46 acts as an injection ram and forces the material through the nozzle 42 and into the mold cavity 16. The nozzle 42 generally has a non-return valve (not shown) at the open end thereof, and the screw 46 has a non-return valve (not shown), to prevent the backflow of material.

The first composition injector is not meant to be limited to the embodiment shown in FIG. 1 but can be any apparatus capable of injecting a thermoplastic composition into the mold cavity. For example, the injection molding machine can have a mold half movable in a vertical direction such as in a “stack-mold” with center injection. Other suitable injection molding machines include many of those available from Cincinnati-Milacron, Inc. of Cincinnati, Ohio; Battenfeld Gloucester Engineering Co, Inc. of Gloucester, Mass.; Engel Machinery Inc. of York, Pa.; Husky Injection Molding Systems Ltd. of Bolton, Canada; BOY Machines Inc. of Exton, Pa. and others.

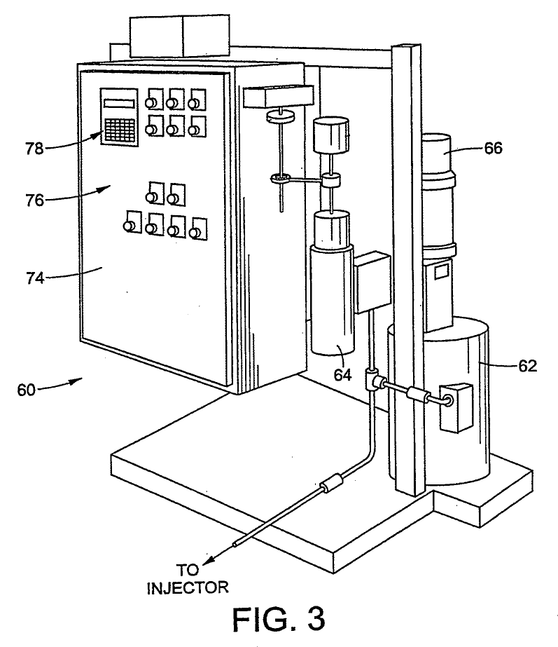

FIG. 3 shows an in-mold coating dispense and control apparatus 60 adapted to be connected to the molding apparatus 10 and provide in-mold coating capabilities and controls therefor to the molding apparatus 10. The control apparatus 60 includes an in-mold coating container receiving cylinder 62 for holding an in-mold coating container such as a vat of an in-mold coating composition. Suitable in-mold coating compositions include those disclosed in U.S. Pat. No. 5,777,053. The control apparatus 60 further includes a metering cylinder or container 64 that is adapted to be in fluid communication with the in-mold coating container when received in the receiving cylinder 62. A transfer pump 66 is provided on the control apparatus 60 and is capable of pumping the in-mold coating composition from the receiving cylinder to the metering cylinder 64 as will be described in more detail below.

The metering cylinder 64 is selectively fluidly connectable to the second injector 32 on the molding apparatus 10. The metering cylinder 64 includes a hydraulic means such as a hydraulic piston for evacuating in-mold coating from the metering cylinder and directing the evacuated in-mold coating to the second injector 32. A return line (not shown) is connected to the second injector 32 and to the receiving cylinder 62 to fluidly communicate therebetween.

The control apparatus 60 further includes an electrical box 74 capable of being connected to a power source. The electrical box 74 includes a plurality of controls 76 and a touch pad or other type of controller 78 thereon for controlling the dispensing of in-mold coating to the mold cavity 16 of the molding apparatus 10 as will be described in more detail below. A compressed air connector (not shown) is provided on the control apparatus for connecting the control apparatus to a conventional compressed air line. Compressed air is used to drive the transfer pump 66 and remove in-mold coating from the control apparatus and its fluid communication lines during a “cleanout” operation. Additionally, air can be used to move a solvent through the communication lines for cleaning purposes.

The dispense and control apparatus 60 may include a remote transmitter (not shown) that is adapted to be positioned, in the preferred embodiment, on one of the mold halves 12, 14. The transmitter may be, for example, a conventional rocker switch that sends a signal to the control apparatus upon actuation. The transmitter may be positioned on one of the mold halves 12, 14 such that it is actuated upon closure of the mold halves. The signal sent from the transmitter is used to initiate a timer (not shown) on the control apparatus.

Alternatively, the molding apparatus 10 may be equipped with a transmitter or transmitting means that has the ability to generate a signal upon closure of the mold halves 12, 14. Such transmitters are known in the art. A conventional signal transfer cable could be connected between the molding apparatus 10 and the control apparatus 60 for communicating the signal to the control apparatus. Such an arrangement would eliminate the need for an independent transmitter to be connected to one of the mold halves.

The control apparatus also preferably includes at least one remote sensor (not shown) that is adapted to be positioned on one of the mold halves to record or measure the internal pressure and/or temperature within the mold cavity 16. This sensor can be any known type of such sensor including, for example, a pressure transducer, thermocouple, etc. The sensor(s) and control apparatus 60 are operatively connected via conventional means to allow measurement signals to pass therebetween.

To prepare for injection of the in-mold coating composition into the mold cavity, an in-mold coating container of a desired in-mold coating composition is placed in the receiving cylinder 62. The metering cylinder 64 is fluidly connected to the second injector 32. The return line 88 is fluidly connected to the second injector 32 and the receiving cylinder 62. The control apparatus 60 is connected to a suitable power source such as a conventional 460 volt AC or DC electrical outlet to provide power to the electrical box 74. The remote sensor is appropriately positioned on one of the mold halves 12, 14 as described above.

To make an in-mold coated thermoplastic article, with reference to FIG. 1, a thermoplastic first composition is placed in the hopper 44 of the molding apparatus 10. The first injector 30 is moved into nesting or mating relation with the fixed mold half 12. Through conventional means, i.e., using the heated extruder barrel 48 and the rotating screw 46, the first injector 30 heats the first composition above its melting point and directs the heated first composition toward the nozzle 42 of the first injector 30. The mold halves 12,14 are closed thereby creating the contained molding cavity 16. As described above, the, if present, is positioned on one of the mold halves such that when the mold halves are closed together the transmitter sends a signal to the control apparatus 60 indicating that the mold halves are closed and that the molding process has begun.

Upon receipt of the signal, hereinafter referred to as T₀, the dispense and control apparatus 60 initiates the timer contained therein. The timer is used to track elapsed time from T₀. At predetermined elapsed time intervals, the control apparatus 60 actuates and controls various in-mold coating related functions to insure that the in-mold coating is delivered to the cavity 16 at a desired point in the molding process. Thus, the apparatus 60 operates concomitantly with the molding apparatus 10.

After T₀, the molding process continues and a nozzle valve (not shown) of the nozzle 42 is moved to an open position for a predetermined amount of time to allow a corresponding quantity of the first thermoplastic composition to enter the mold cavity 16 through the orifice 38. The screw 46 provides a force or pressure that urges the first composition into the mold cavity 16 until the nozzle valve is returned to its closed position. The first composition is filled and packed into the mold cavity 16 as is well known in the art. Once the mold cavity 16 is filled and packed, the molded first composition is allowed to cool to a temperature below its melting point. As will be understood by those in the art, the thermoplastic will not cool uniformly, with the thermoplastic forming the interior of the molded article generally remaining molten while the surface begins to harden as it cools more quickly.

The injection of the thermoplastic used to form the substrate in the mold can be viewed as a three-stage process. The first stage is referred to as the filling stage. In this stage, an amount of thermoplastic is injected into the mold to nearly fill the mold, preferably to at least about 75% of its capacity. The second stage is referred to as the packing stage. In this stage, additional thermoplastic is packed into the mold to fill the mold cavity, preferably to at least about 99% of its capacity. The third stage is referred to as the cooling stage. In this stage, the thermoplastic begins to solidify as it starts to cool.

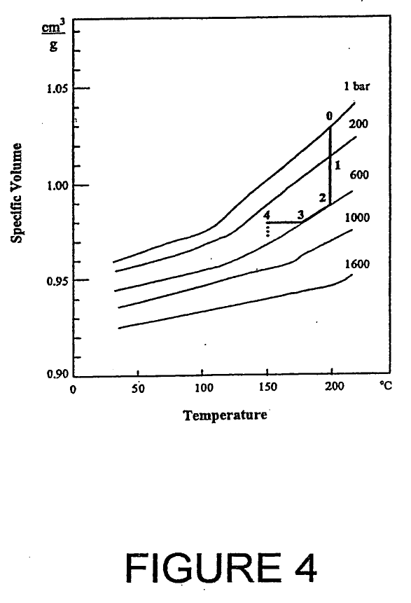

The Pressure-Specific Volume-Temperature (PVT) relationship of a typical thermoplastic substrate is shown in FIG. 4. From FIG. 4, it can be seen that the injection pressure rises in the thermoplastic filling stage (0-1). In the packing stage, packing pressure rises as a result of injecting more thermoplastic material into the mold (1-2) and then is kept constant for a while to compensate for the material shrinkage caused by the temperature decrease as the thermoplastic begins to cool (2-3). During thermoplastic cooling stage, the pressure in the mold cavity decreases as the thermoplastic continues to cool and begins to shrink (3-4). It is during the thermoplastic cooling stage (3-4) that the IMC coating is injected into the mold.

After injection, the resin in the mold cavity begins to solidify, at least to an extent such that the substrate can withstand injection and/or flow pressure subsequently created by introduction of the coating composition. During this solidification, the forming article cools somewhat and this is believed to result at least a slight shrinkage, i.e., a small gap is created between the forming article and surfaces 34 and 36. Clearly, some type of active movement of the forming article away from surfaces 34 and 36 could be undertaken but has not proven necessary. After the injected thermoplastic has achieved a suitable modulus, the coating composition can be injected. A predetermined amount of coating composition is utilized so as to provide a coating having, for example, a desired thickness and density.

As described above, one will preferably wait until the surface of the substrate has sufficiently cooled and hardened such that the in-mold coating and the thermoplastic will not excessively intermingle. Also, the longer the period between the end of the thermoplastic filling and the coating injection, generally the lower the packing pressure needed to inject the coating and the easier the injection. However, because the in-mold coating generally relies on the residual heat of the cooling thermoplastic to cure, one risks inadequate curing of the in-mold coating if the waiting period is too long. In addition, the thermoplastic needs to remain sufficiently molten both to allow for sufficient adhesion between the in-mold coating and the substrate as well as to provide sufficient compressability to allow adequate flow of the in-mold coating around the surface of the substrate in the mold. Thus, the ease of coating injection needs to be balanced with the need for sufficient residual heat to obtain an adequate curing of the in-mold coating.

After the first composition has been injected into the mold cavity 16 and the surface of the molded article to be coated has cooled below the melt point or otherwise reached a temperature or modulus sufficient to accept or support an in-mold coating but before the surface has cooled too much such that curing of the in-mold coating would be inhibited, a predetermined amount of an in-mold coating is ready to be introduced into the mold cavity from an orifice 40 (FIG. 2) of second composition or in-mold coating injector 32.

This point in the molding process can be characterized as a specific internal mold pressure. Specifically, and as discussed previously, in one embodiment the sensor may be a pressure transducer that sends signals indicating the internal pressure in the mold cavity to the control apparatus 60 at various intervals. These signals can be used to determine that the thermoplastic substrate has sufficiently cooled to allow the IMC to be injected. As detailed above, the IMC should be injected soon after the surface of the thermoplastic has cooled enough to reach its melt temperature. The determination of when the melt temperature is reached can be determined by observation of the internal mold pressure. As noted, when the molded part reaches its melt temperature and begins to solidify, it contracts somewhat, thus reducing the pressure in the mold, which is recorded through the use of the pressure transducer in the mold. The exact pressure value at which the specific thermoplastic begins to solidify is obviously dependent on the exact type of thermoplastic being used in the molding process. Specific values for individual thermoplastics can be determined from PVT charts for those thermoplastics, such as shown in FIG. 4, or by experimentation.

At predetermined internal pressure, the control apparatus 60 actuates and controls various in-mold coating related functions to insure that the in-mold coating is delivered to the cavity 16, referred to herein as T_{IMC}, at a desired point in the molding process. Thus, the apparatus 60 operates concomitantly with the molding apparatus 10.

One such function is filling the metering cylinder 64 with a desired amount of in-mold coating. This function occurs in advance of T_{IMC}. Thus, at the correct moment, the control apparatus 60 opens a valve (not shown) that permits fluid communication between the in-mold coating-filled container and the metering cylinder 64. The transfer pump 66 then pumps in-mold coating from the container to the metering cylinder. When the metering cylinder 64 is filled a desired amount, the valve closes to prevent more in-mold coating from entering the cylinder. The amount of in-mold coating permitted to enter the cylinder 64 is selectively adjustable as will be described in more detail below.

After the metering cylinder 64 is filled and just prior to T_{IMC}, the control apparatus 6b opens a pin or valve (not shown) on the second injector 32 to allow fluid communication between the second injector 32 and the mold cavity 16. The valve is normally bias or urged toward a closed position, i.e., flush to the mold surface, but is selectively movable toward the open position by the control apparatus 60. Specifically, an electrically powered hydraulic pump (not shown) of the control apparatus is used to move the pin. Immediately or very shortly thereafter, at when the predetermined internal mold pressure is reached, the hydraulic means of the metering cylinder 64 evacuates the in-mold coating contained therein and delivers the in-mold coating to the second injector 32 where it passes through the orifice 40 and into the mold cavity 16.

Once coating composition has been injected into mold cavity 16, second injector 32 is deactivated, thus causing the flow of coating composition to cease. The coating composition flows around the molded article and adheres to its surface. Curing or crosslinking of the coating composition can be caused by the residual heat of the substrate or mold halves, or by reaction of the composition components. The in-mold coating subsequently cures in the mold cavity and adheres to the substrate surface to which the same was applied. The curing can be caused by the residual heat of the substrate or mold halves and/or by reaction between the coating composition components. If the residual heat of the substrate is used to effect curing, it is important to inject the in-mold coating before the molded article has cooled to the point below where proper curing of the coating can be achieved. The in-mold coating requires a minimum temperature to activate the catalyst present therein which causes a cross-linking reaction to occur, thereby curing and bonding the coating to the substrate.

It is known that the pressure in the mold cavity 16 will initially rise during the injection stage while the thermoplastic resin fills the mold cavity. The pressure will rise further as the mold cavity is packed. Finally, the pressure in the mold cavity will begin to decrease as the thermoplastic molded article cools and begins to solidify, which may recorded through the use of a pressure transducer and relayed to the control apparatus 60. At a predetermined pressure during the cooling phase, the in-mold coating is injected into the mold cavity. The predetermined pressure is generally based on the specific type of thermoplastic resin used and may also be based on the specific type of in-mold coating composition used.

The in-mold coating is injected into the mold cavity at a pressure ranging generally from about 3.5 to about 35 MPa, desirably from about 10 to about 31 MPa, and preferably from about 13.5 to about 28 MPa.

In the above described process, the mold is generally not opened or unclamped before the in-mold coating is applied. That is, the mold halves maintain a parting line and generally remain substantially fixed relative to each other while both the first and second compositions are injected into the mold cavity. The in-mold coating composition spreads out from the mold surface and coats a predetermined portion or area of the molded article. Immediately or very shortly after the in-mold coating composition is fully injected into the mold cavity 16, the nozzle valve or deactivation means of the second injector 32 is engaged, thereby preventing further injection of the in-mold coating into the mold cavity.

The in-mold coatings of the present invention are generally flexible and can be utilized on a variety of injection molded substrates, including thermoplastics and thermosets. Thermoplastic molding resins which can be used to make articles capable of being coated by means of the foregoing composition include acrylonitrile-butadiene-styrene (ABS), phenolics, polycarbonate (PC), thermoplastic polyesters, polyolefins including polyolefin copolymers and polyolefin blends, PVC, epoxies, silicones, and similar thermo-plastic resins, as well as alloys of such molding resins. Preferred thermoplastic resins include PC and PC alloys, ABS, and alloy mixtures of PC/ABS.

Between in-mold coating injections, the control apparatus 60 uses the transfer pump 66 to circulate the in-mold coating composition through the system. The valve on the second injector 32 remains in its closed position thereby preventing any in-mold coating composition from entering the mold cavity 16. One purpose of circulating the in-mold coating between cycles is to prevent any particular portion of the coating from becoming undesirably heated due to its proximity to heating mechanisms on the molding apparatus 10. Such heating could detrimentally impact the material properties of the in-mold coating or could “lock-up” the in-mold coating fluid lines by solidifying the in-mold coating composition therein.

The controls 76 and keypad 78 of the control apparatus 60 enable an operator to adjust and/or set certain operating parameters of the apparatus. For example, the controls can be manipulated to increase or decrease the amount of in-mold coating to be filled in the metering cylinder 64 by allowing the valve that controls communication between the metering cylinder 64 and the receiving cylinder 62 to remain-open for a longer duration. Additionally, the controls can be manipulated to adjust the point that the metering cylinder 64 is filled by the transfer pump 66 and/or the point at which the cylinder 64 is emptied by the hydraulic means.

In an alternate embodiment, the sensor is a temperature sensor, such as a thermocouple, mounted adjacent the mold cavity and adapted to record a temperature in the mold cavity. In this case, rather than using the internal mold pressure as a guide to when to inject the IMC, in this embodiment the control apparatus injects in-mold coating into the mold cavity based on the temperature recorded in the mold cavity by the temperature sensor. As detailed above, the internal temperature in the mold will decrease as the thermoplastic begins to cool. The general nature of this for a typical thermoplastic can be seen in FIG. 4. In either case, the in-mold coating is desirably injected into the mold cavity at the same point in the molding process irrespective of what type of sensor is used. Thus, rather than being pressure dependent, this embodiment is temperature dependent. The use of a temperature sensor may also be useful as an alarm to stop the molding process or otherwise indicate that tool temperature is above or below the defined or preferred process temperatures.

Based on the pressure measurements taken by the pressure transducer sensor, the series of functions performed by the control apparatus can also be dependent on the pressure measured in the mold cavity. Thus, rather than being determined by elapsed time from T₀, each of the above described functions prior to injection of the in-mold coating may occur at a predetermined pressure in the mold cavity so that the in-mold coating can be injected into the cavity at the desired point in the molding process.

The use of the terms “transducer” is meant to any type of sensor or other means for measuring or recording a value for an associated variable. Thus, e.g., it should be understood by those skilled in the art that the pressure transducer could alternatively be a plurality of pressure transducers positioned at varying locations around the mold cavity. In this arrangement, the control apparatus would perform its functions, including injecting the in-mold coating, based on a plurality of pressure measurements. For example, the control apparatus could perform its functions based on predetermined pressure averages of the plurality of pressure measurements taken by the plurality of pressure sensors. This arrangement may be desirable because a plurality of pressure transducers may be able to better determine the actual pressure observed in the mold cavity.

As mentioned, the internal mold pressure at which the in-mold coating is injected may vary with the configuration of the mold (i.e. the shape of the part being manufactured) and the polymeric materials being used for the substrate and the coating. In order to optimize these and the other critical operating parameters of the process, a series of trial runs may be conducted with the mold and the specific polymeric materials. Injection of the in-mold coating at various internal mold pressures may be tried to determine an exact pressure that gives optimal results. The optimum pressure at which to inject preferably corresponds to a point in the molding cycle when the thermoplastic substrate just reaches its melting temperature and its outer surface begins to solidify.

Two problems that can occur with the coating of the thermoplastic substrate are intermingling of the IMC with the thermoplastic substrate, resulting in poor surface appearance, and poor adhesion of the IMC to the thermoplastic. Intermingling is typically caused by premature injection of the IMC into the mold before the thermoplastic surface sufficiently cools to begin hardening while poor adhesion is typically caused by injecting the IMC too late after the thermoplastic begins cooling, such that there is not enough residual heat to sufficiently cure the IMC and/or melt bond it to the surface of the thermoplastic substrate. If intermingling of the IMC and the thermoplastic is discovered, then the IMC should be injected at a lower internal mold temperature when the thermoplastic has further cooled. If poor adhesion or incomplete curing of the IMC is found, then the IMC should be injected when the internal pressure is greater, indicating less cooling and a higher thermoplastic temperature.

The exact time at which the thermoplastic has reached its melting temperature can be determined in several ways. By the use of temperature transducers, as explained above, it is possible to determine when the melt temperature is reached by comparing the measured value with the known melt temperature, as determined from previous experiment or from reported literature values. Alternately, the determination of when the melt temperature is reached can be determined indirectly by observation of the internal mold pressure. Finally, the determination can be made using elapsed time from T₀ using results from previous trials for a known thermoplastic and mold temperature.

Some conventional injection molding machines and molds are already equipped with one or more pressure transducers adapted to measure resistance of the mold clamping mechanisms to mold opening created by the injection of the thermoplastic introduced into the mold. These machines are often capable of sending the measured pressure or pressures to associated equipment such as the control apparatus 60 through conventional data transfer means. In this case, the need for a remote pressure transducer sensor of the control apparatus can be eliminated. The control apparatus need only be connected to the injection molding machine 10 to receive pressure measurements taken from the cavity 16.

In another alternative embodiment of the present invention, the internal mold pressures and/or temperatures are forwarded to a data collection means operatively associated with the dispense and control apparatus 60. The data collection means can be an on-board hard drive or other recording medium that is capable of recording the operating parameters set on the control apparatus for one or a series of molded articles. For example, the data collection means could record the internal mold pressure and/or temperature at which that the various control apparatus functions are set to use and/or the actual internal mold pressure and/or temperature at which the various functions occur.

For example, for each injection of in-mold coating, the data collection means could record the internal mold pressure at the time the various functions of the control apparatus occur. Of course other functions could also be recorded including without limitation the number of in-mold coating injections for a specific amount of in-mold coating, the hydraulic pressure used to evacuate the metering cylinder 64, etc. Likewise, if the sensor is a thermocouple, the temperature measurements taken thereby can be recorded and correlated with the control apparatus functions as well.

In any case, the data or information recorded by the data collection means can be used for quality control purposes. For example, a specific in-mold coated part can be examined upon being ejected from the mold cavity and compared against the data collected on the specific injection of in-mold coating associated with that particular part. If the part does not meet certain quality control requirements such as lack of adhesion between the coating and the thermoplastic, lack of scratch resistance, surface imperfections, lack of adequate coating coverage, etc., the present parameters, whether time dependent or pressure dependent, can be adjusted as detailed above to improve the coating characteristics of future coated parts.

The control apparatus can also be equipped with a means for transferring collected data. This could be through any conventional means including providing a disk drive or the like that allows the data to be recorded to a mobile storage medium, providing a data link that is connectable to a local computer, an intranet, the internet, etc. Such means for transferring data could allow remote analysis of the collected data in real-time.

To ease the correlation between the operating parameters and the parts produced using the stated parameters, the control apparatus 60 may include, e.g., a conventional bar code reader (not shown) or other electronic identification means. The bar code reader can be used to scan a bar code on a particular container of in-mold coating placed in the receiving cylinder 62 and injected onto a plurality of molded parts. Used in conjunction with the data collection means described above, the bar code for a particular container of in-mold coating can be associated with data recorded for all injections of in-mold coating from the particular container of coating. Further, the bar code of the in-mold coating container can be associated with a finished parts bin or collection means that receives finished parts with a coating thereon from the molding apparatus. Recording and storing such information allows particular finished parts to be analyzed and easily compared against the data recorded thereabout and the particular in-mold coating used. This in turn allows for a more effective quality control of produced parts.

To more quickly and easily optimize the parts produced using the present quality assurance method, the control apparatus may be provided with a user interface that allows a user to simply select a part icon that represents a series of parts to be molded and coated. Selection of a specific part icon on the user interface presets the control parameters previously optimized as described above on the control apparatus whether they are time-based, mold pressure based, or otherwise. The user interface eliminates the need for an operator to set the control parameters individually each time a new part series is to be run through the molding and coating process.

In any of the embodiments discussed herein, the control apparatus 60 can be provided with a display means such as a monitor (not shown). The display means can display, in real time, any of the data or information being sensed and/or recorded by the control apparatus.

The invention has been described with reference to the preferred embodiments. Obviously, modifications and alterations will occur to others upon reading and understanding the preceding detailed description. It is intended that the invention be construed as including all such modifications and alterations.

1. A method for determining when to inject a coating for contacting a surface of a molded article in a mold in an In-mold coating process, the method comprising the steps of:
determining an internal mold pressure after a mold has been filled with a predetermined amount of a thermoplastic;
using a data collection means associated with a control apparatus, monitoring over time the internal mold pressure as said thermoplastic cools in the mold; and
determining from a change in the internal pressure that a surface of said thermoplastic has cooled to below its melt temperature.

2. A method according to claim 1, wherein said change in internal pressure is a reduction in pressure.

3. A method according to claim 1, wherein the internal pressure rises as said thermoplastic in injected into said mold, and subsequently decreases as said thermoplastic cools.

4. A method for in-mold coating a thermoplastic substrate, the method comprising the steps of:
injecting a thermoplastic substrate into a closed mold, wherein at least one of an internal mold temperature and an internal mold pressure is monitored;
allowing a surface of said thermoplastic to cool to a point below its melting temperature to form a molded article;
injecting a coating into said closed mold such that said coating contacts at least a part of said surface of said thermoplastic, wherein said coating is injected at a point wherein at least one of said internal mold temperature and internal mold pressure is indicative of the point when said thermoplastic has cooled to below its melting temperature as determined by using a data collection means associated with a control apparatus.

5. A method according to claim 4, wherein said internal mold temperature and internal mold pressure is measured by a sensor.

6. A method according to claim 5, wherein a measurement determined by said sensor is relayed to the control apparatus controlling the injection of said coating.

7. A method for ensuring the quality of in-mold coated thermoplastic parts, the method comprising the steps of:
a) manufacturing an in-mold coated thermoplastic part by molding a thermoplastic using a first set of process conditions in a closed mold to form a substrate and subsequently contacting an in-mold coating with said substrate by injecting an in-mold coating into said closed mold;
b) inspecting the coated thermoplastic part;
c) determining whether the molding of the thermoplastic should be optimized for failure to meet defined quality control standards;
d) optimizing the process conditions of the molding of the thermoplastic by adjusting one or more of injection volume, injection temperature, injection pressure, and molding pressure;
e) determining whether the coating of the substrate should be optimized for failure to meet defined quality control standards; and
f) optimizing the process conditions of the coating of the substrate by adjusting one or more of cure time, injection time, Injection pressure, injection volume, injection temperature, or mold temperature at injection for said in-mold coating.

8. A method according to claim 7, wherein step c) is performed by determining whether said thermoplastic substrate exhibits at least one of voids and inadequate filling of said mold.

9. A method according to claim 7, wherein said first set of process conditions includes: one or more injection pressures for said thermoplastic, one or more injection temperatures for said thermoplastic, one or more injection volumes for said thermoplastic, one or more injection times for said thermoset, one or more injection pressures for said thermoset one or more injection volumes for said thermoset, and one or more cure times for said thermoset.

10. A method according to claim 7, wherein step e) is performed by at least one of determining whether said coating is intermingled with said substrate, determining whether a surface appearance of said coating is acceptable for a defined end use, and determining whether there is sufficient adhesion between said coating and said substrate.

11. A method according to claim 7, wherein said coating is injected into said mold at a point after said thermoplastic has cooled to a temperature below its melt temperature.

12. A method according to claim 11 wherein said point is determined by the monitoring of a temperature in said mold.

13. A method according to claim 11, wherein said point is determined by the monitoring of an internal pressure in said mold.

14. A method according to claim 7, wherein steps a)-f) are performed repeatedly until an in-mold coated thermoplastic part is produced that meets defined quality standards.

15. A method according to claim 7, wherein step f) is performed by at least one of 1) adjusting a time at which said in-mold coating is injected into said mold relative to a time at which the molding process is begun, and 2) adjusting a time at which said mold is opened and the coated part is removed from said mold relative to a time at which said in-mold coating is injected into said mold.

16. A method according to claim 7, wherein step f) is performed by adjusting an injection pressure for said in-mold coating.

17. A method according to claim 7, wherein values for one or more of said process conditions for said molding and coating steps are controlled and recorded by a control apparatus operatively associated with said mold.

18. A method according to claim 7, wherein said optimized process conditions are stored in a control apparatus associated with said mold and may be recalled for use in future molding processes.
